(19) United States
(12) Patent Application Publication
(10) Pub. No.: US 2017/0220056 A1
(43) Pub. Date: Aug. 3, 2017

(54) TWO-STAGE VALVE

(71) Applicant: ISRAEL AEROSPACE INDUSTRIES LTD., Lod (IL)

(72) Inventors: Bernhard Grumer, Herzliya (IL); Sergey Ibragimov, Ramla (IL)

(21) Appl. No.: 15/500,855

(22) PCT Filed: Jul. 29, 2015
(86) PCT No.: PCT/IL2015/050778

§ 371 Date: Jan. 31, 2017

(30) Foreign Application Priority Data
Aug. 4, 2014 (IL) 233943

(51) Int. Cl. G05D 23/02; F16K 17/00; F16K 17/38

(52) U.S. Cl. CPC G05D 23/022; F16K 17/38; F16K 17/003; F01P 7/16

(57) ABSTRACT

A valve assembly is provided, including at least a first valve unit and a second valve unit. The first valve unit is movably mounted within the second valve unit, and includes a first valve housing defining a first valve volume. The second valve unit includes a second valve housing defining a second valve volume different from the first valve volume. The second valve housing includes at least one first port and at least one second port. The first valve unit includes a first valve element reciprocably movable with respect to the first valve seat to selectively open and close a first fluid path through the first valve volume, and a first mechanical biasing element. The second valve unit includes a second valve element reciprocably movable with respect to the second valve seat to selectively open and close a second fluid path through the second valve chamber, the second valve element being affixed to first valve housing for reciprocal movement therewith; and a second mechanical biasing element. The first valve unit is connectable to a reciprocable actuator element, the first valve element and the second valve elements being reciprocally movable responsive to reciprocal movement of the reciprocable actuator element to selectively open the first flow path and the second flow path, respectively.

### TECHNOLOGICAL FIELD

The presently disclose subject matter relates to valves, in particular to two port valves and thermostatic valves.

### BACKGROUND ART

References considered to be relevant as background to the presently disclosed subject matter are listed below:
U.S. Pat. No. 3,851,629
U.S. Pat. No. 4,055,298
U.S. Pat. No. 4,196,847
U.S. Pat. No. 4,537,158
U.S. Pat. No. 4,550,693
U.S. Pat. No. 4,674,679
U.S. Pat. No. 4,942,849
U.S. Pat. No. 4,964,371
U.S. Pat. No. 4,978,060
U.S. Pat. No. 5,294,046
U.S. Pat. No. 5,385,296
U.S. Pat. No. 5,395,041
U.S. Pat. No. 5,482,010
U.S. Pat. No. 5,488,937
U.S. Pat. No. 5,529,282
U.S. Pat. No. 5,690,276
U.S. Pat. No. 5,775,270
U.S. Pat. No. 5,866,882
U.S. Pat. No. 5,960,860
U.S. Pat. No. 5,961,037
U.S. Pat. No. 6,145,538
U.S. Pat. No. 6,196,168
US 2002/0053325
US 2002/088274
US 2003/0136357
US 2005/0268866
US 2006/185362
US 2007/079774
US 2009/007857
US 2009/0165735
US 2009/0173295
US 2009/255488
US 2010/282191
GB 968,073
GB 717,478
GB 1,082,501
DE 10144844
DE 19538285
DE 29622827
DE 102004058869
EP 767299
JP 2010-249143
JP 4052240

Acknowledgement of the above references herein is not to be inferred as meaning that these are in any way relevant to the patentability of the presently disclosed subject matter.

### BACKGROUND

Valves come in many varieties and have many known uses.

One class of valves includes two-port valves, in which the valve has a port at each end thereof having a flow path through the valve only between the two ports. The valve operates to open, close and in some cases variably control the flow of fluid through the flow path between the two ports.

In some examples of such two-port valves that operate as thermostats, a temperature sensitive plunger is displaced responsive to a change in temperature, and thereby regulates the opening and closing of the valve, allowing cooling fluid to pass therethrough and towards a heat source (for example an engine block) when a temperature threshold is reached, enabling the heat source to transfer heat and thereby become cooled.

By way of non-limiting example, U.S. Pat. No. 5,690,276 discloses a thermostat having a main valve and a secondary valve both of which are biased closed by a single coiled compression spring and opened by a single piston. The entrance to the channel of the secondary valve is maintained at a maximum dimension of approximately 0.015 inches in order to keep undesirable particulate matter out of the valve. The surfaces within the valve channel encourage laminar flow which increases the volume of flow which can be passed through the valve while keeping the total surface area of the valve small.

### GENERAL DESCRIPTION

According to a first aspect of the presently disclosed subject matter, there is provided a valve assembly comprising at least a first valve unit and a second valve unit:
the first valve unit movably mounted within the second valve unit, the first valve unit comprising a first valve housing defining a first valve volume, and the second valve unit comprising a second valve housing defining a second valve volume different from said first valve volume, the second valve housing further comprising a first port set comprising at least one first port and a second port set comprising at least one second port;
the first valve unit further comprising:
   a first valve seat defined in the first valve housing,
   a first valve element reciprocably movable with respect to the first valve seat between a first open position and a first closed position to respectively selectively open and close a first fluid path defined between said first port set and said second port set through the first valve volume,
   a first mechanical biasing element cooperating with the first valve element for biasing the first valve element in the first closed position;
the second valve unit further comprising:
   a second valve seat defined in the second valve housing,
   a second valve element reciprocably movable with respect to the second valve seat between a second open position and a second closed position to respectively selectively open and close a second fluid path defined between said first port set and said second port set through the second valve chamber, said second valve element being affixed to first valve housing for reciprocal movement therewith,
   a second mechanical biasing element different from said first biasing element and cooperating with the second valve element for biasing the second valve element in the second closed position;
wherein the first valve unit is connectable to a reciprocable actuator element, the first valve element and the second valve elements being reciprocally movable responsive to reciprocal movement of the reciprocable actuator element to selectively open the first flow path and the second flow path, respectively.

For example, the first valve element and the second valve elements are reciprocally movable sequentially responsive to reciprocal movement of said reciprocable actuator element. For example, said first biasing element and the second biasing element are configured for allowing said first valve element to open to said first open position at a first displacement of the first valve element and for the second valve element to open to said second open position at a second displacement of the first valve element, the second valve displacement being subsequent to said first displacement. For example, said first biasing element is less stiff than said first biasing element.

For example, said first biasing element and the second biasing element are configured for allowing said second valve element to open to said second open position at a first displacement of the first valve element and for the first valve element to open to said first open position at a second displacement of the first valve element, the second valve displacement being subsequent to said first displacement. For example, said first biasing element is stiffer than said first biasing element.

For example, the first valve element and the second valve elements are concurrently movable sequentially responsive to reciprocal movement of said reciprocable actuator element.

For example, said first biasing element comprises a prestressed first spring element having one axial end thereof fixed to the first valve element, and a second axial end thereof fixed to a spring seat provided in said first valve housing. For example, said first spring element is a first helical spring.

The valve assembly according to any one of claims 1 to 9, wherein said second biasing element comprises a prestressed second spring element having one axial end thereof fixed to the second valve element, and a second axial end thereof fixed to a spring seat provided in said second valve housing.

For example, said second spring element is a second helical spring. For example, the valve assembly further comprises the reciprocable actuator element. For example, the reciprocable actuator element comprises a piston element reciprocably movable with respect to a piston housing, the piston housing being fixed to the second valve housing, and the piston element being fixed to the first valve element. For example, the reciprocable actuator element is movable responsive to being exposed to a temperature above a threshold temperature. For example, the reciprocable actuator element comprises a thermally expansive material.

For example, the valve assembly further comprises at least one bleeding orifice for allowing a limited fluid flow to be present through the valve assembly whenever there is a pressure difference across the valve assembly. For example, the at least one bleeding orifice is provided in the first valve unit. For example, the at least one bleeding orifice is provided in the second valve unit.

In at least one example, the valve assembly operates as a thermostat.

According to the first second aspect of the presently disclosed subject matter there is also provided a valve assembly, including at least a first valve unit and a second valve unit. The first valve unit is movably mounted within the second valve unit, and includes a first valve housing defining a first valve volume. The second valve unit includes a second valve housing defining a second valve volume different from the first valve volume. The second valve housing includes at least one first port and at least one second port. The first valve unit includes a first valve element reciprocably movable with respect to the first valve seat to selectively open and close a first fluid path through the first valve volume, and a first mechanical biasing element. The second valve unit includes a second valve element reciprocably movable with respect to the second valve seat to selectively open and close a second fluid path through the second valve chamber, the second valve element being affixed to first valve housing for reciprocal movement therewith; and a second mechanical biasing element. The first valve unit is connectable to a reciprocable actuator element, the first valve element and the second valve elements being reciprocally movable responsive to reciprocal movement of the reciprocable actuator element to selectively open the first flow path and the second flow path, respectively.

According to a second aspect of the presently disclosed subject matter there is provided a cooling circuit comprising a valve assembly as defined with respect to the first aspect of the presently disclosed subject matter.

According to a third aspect of the presently disclosed subject matter there is provided a method for operating a valve assembly, comprising:
providing in a cooling circuit a valve assembly as defined with respect to the first aspect of the presently disclosed subject matter;
exposing the valve assembly of a first temperature range above the threshold temperature to thereby open the first low path; and
exposing the valve assembly of a second temperature range above the threshold temperature to thereby open the second low path.

In at least one example of the presently disclosed subject matter, the valve assembly can be used for fluid flow therethrough in either direction between the first port set and the second port set.

In at least one example of the presently disclosed subject matter, the valve assembly provides a relatively small opening of flow area through the valve, as a proportion of the maximum valve opening. In at least some cases this allows for a relatively small cooling flow rate to be maintained through the valve for long periods to provide more controlled temperature, as compared to providing multiple cycles of opening and closing a relatively large flow area through a valve to thereby regulate the temperature.

In at least one example of the presently disclosed subject matter, the valve assembly provides for relative ease of installation of the valve assembly in a resilient tube.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is a transverse cross-sectional view of a first example of a valve assembly, in which the first valve unit and the second valve unit are in the respective closed positions.

FIG. 2 is a transverse cross-sectional view of the example of FIG. 1, in which the first unit valve unit is in the open position and the second valve unit is in the open position.

FIG. 3 is a transverse cross-sectional view of the example of FIG. 1, in which the first unit valve unit and the second valve unit are in the respective closed positions.

FIG. 4(a) illustrates an example of the first fluid flow path through the valve assembly for the example of FIG. 2; FIG. 4(b) illustrates an example of the first fluid flow path and the second fluid flow path through the valve assembly for the example of FIG. 3.

FIG. 5 illustrates a variation of aggregate open area through the first valve unit and the second valve unit with stroke.

FIG. 6 illustrates a variation of equivalent diameter of the aggregate open area through the first valve unit and the second valve unit with stroke.

FIG. 7 illustrates a variation of aggregate spring load corresponding to the first valve unit and the second valve unit with stroke.

### DETAILED DESCRIPTION

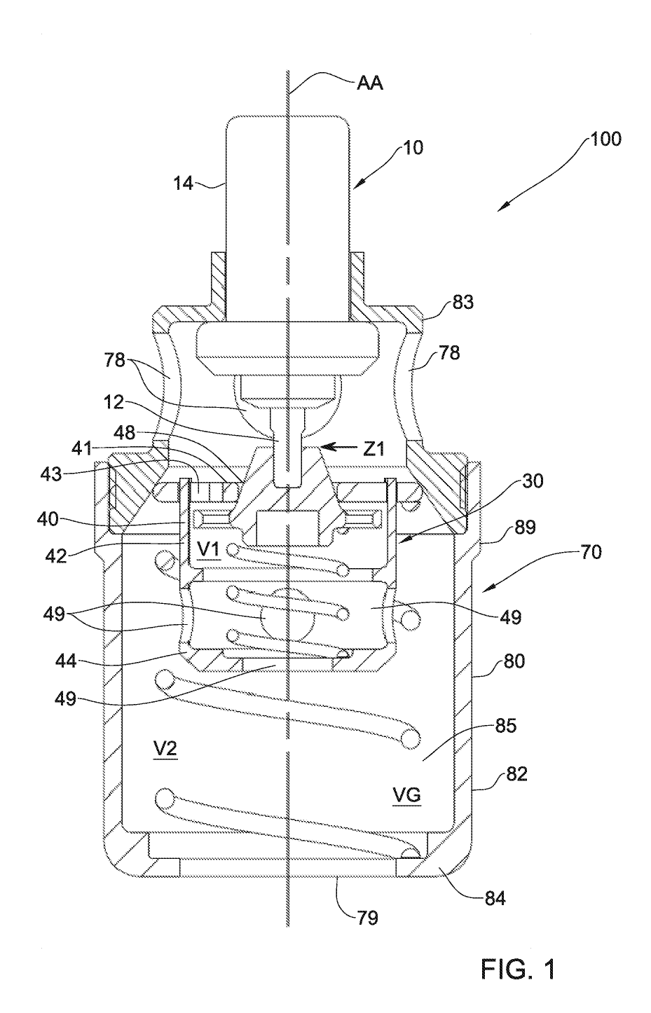

Referring to FIGS. 1 to 3, a valve assembly for a two port valve according to a first example of the presently disclosed subject matter, generally designated 100, comprises a first valve unit 30 and a second valve unit 70, and the valve assembly 100 further comprises a longitudinal axis AA.

The first valve unit 30 is enclosed by and movably mounted within the second valve unit 70, and comprises a first valve housing 40 defining a first valve chamber 45 enclosing a first valve volume V1. The second valve unit 70 comprises a second valve housing 80 defining a second valve chamber 85 enclosing a gross valve volume VG part of which is occupied by the first valve unit 30. Thus the second valve chamber 85 also defines a second valve volume V2 that is different and separate from the first valve volume V1 and corresponds to the gross valve volume VG less the volume occupied by the first valve unit 30 within the gross valve volume VG.

The second valve housing 80 in this example is generally cylindrical, having a cylindrical side wall 82, having a first longitudinal end 83 and a second longitudinal end 84. The first longitudinal end 83 comprises a first port set of first ports 78, in this example four first ports 78, although in alternative variations of this example the first port set can include at least one first port, for example two, three or more than four first inlet ports 78. The second longitudinal end 84 comprises a second port set of second ports 79, in this example one second port 79, although in alternative variations of this example the first port set can include, for example two or more than two second inlet ports 79, i.e., at least one second port 79.

In this example, the housing 80 comprises an external radial shoulder 89 having an external diameter slightly greater than the external diameter of the cylindrical side wall 82, thereby enabling a snug fit with an inside wall of a rubber hose or the like when press-fitted into the rubber hose. For example, the rubber hose can be part of a cooling circuit. This feature allows for easy fitting of the valve assembly 100 in a cooling circuit without the need for tools.

The first port set of first ports 78 and the second port set of second ports 79 provide fluid communication between the outside of the valve assembly 100 and the second valve chamber 85, and allows for selective fluid flow through the gross valve volume VG, i.e., through the first valve volume V1 and/or the second valve volume V2, between first port set of first ports 78 and the second port set of second ports 79, as will become clearer herein.

The first valve housing 40 in this example is generally cylindrical, having a cylindrical side wall 42, having a third longitudinal end 43 and a fourth longitudinal end 44. The third longitudinal end 43 comprises a third port set of third ports 48, in this example one third port 48, although in alternative variations of this example the third port set can include, for example two or more than two third inlet ports 48, i.e., at least one third port 48. The third inlet port 48 is formed in an annular end wall 41 provided at the third longitudinal end 43. The fourth longitudinal end 44 comprises a fourth port set of fourth ports 49, in this example five fourth ports 49, although in alternative variations of this example the fourth port set can include at least one fourth port, for example two, three, four or more than five fourth inlet ports 49.

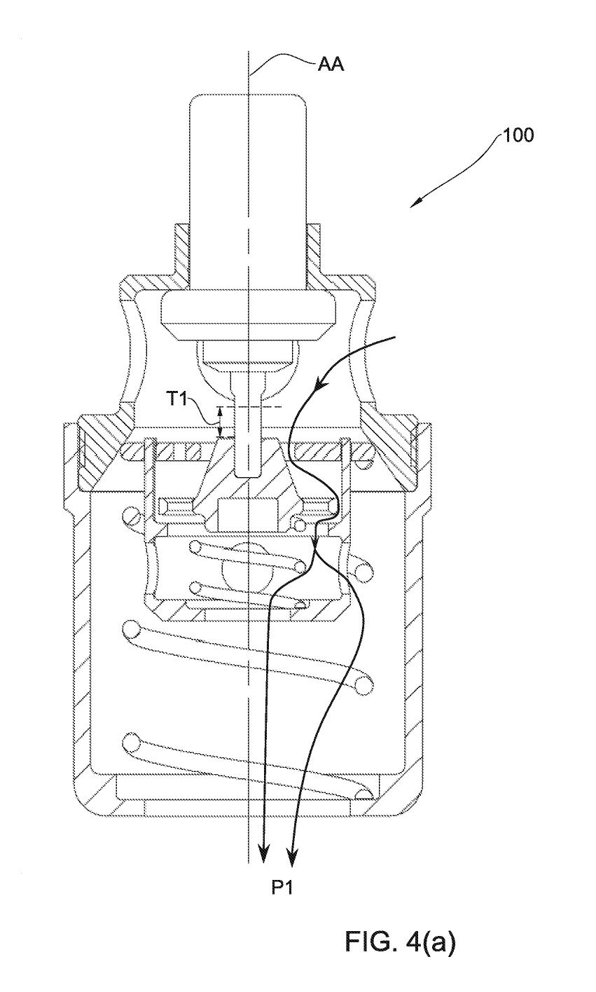

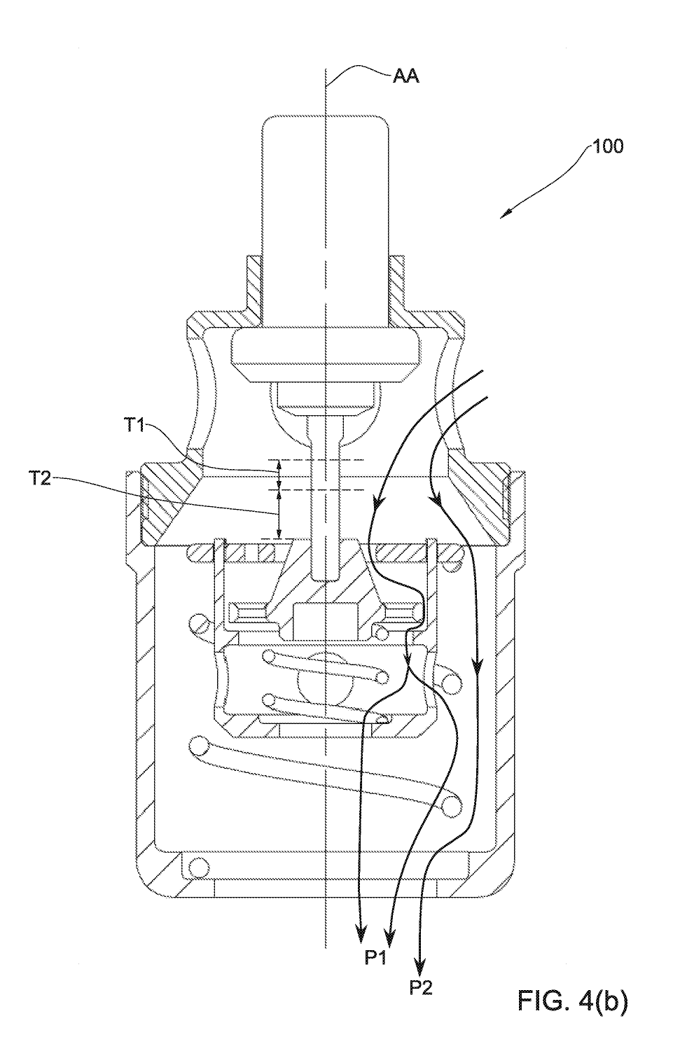

Referring in particular to FIGS. 4(a) and 4(b), two fluid paths P1, P2 can be selectively provided through the valve assembly 100.

The first fluid path P1 can be defined between the first port set and the second port set through the first valve volume V1.

A second fluid path P2 can be defined between the first port set and the second port set through the second valve volume V2.

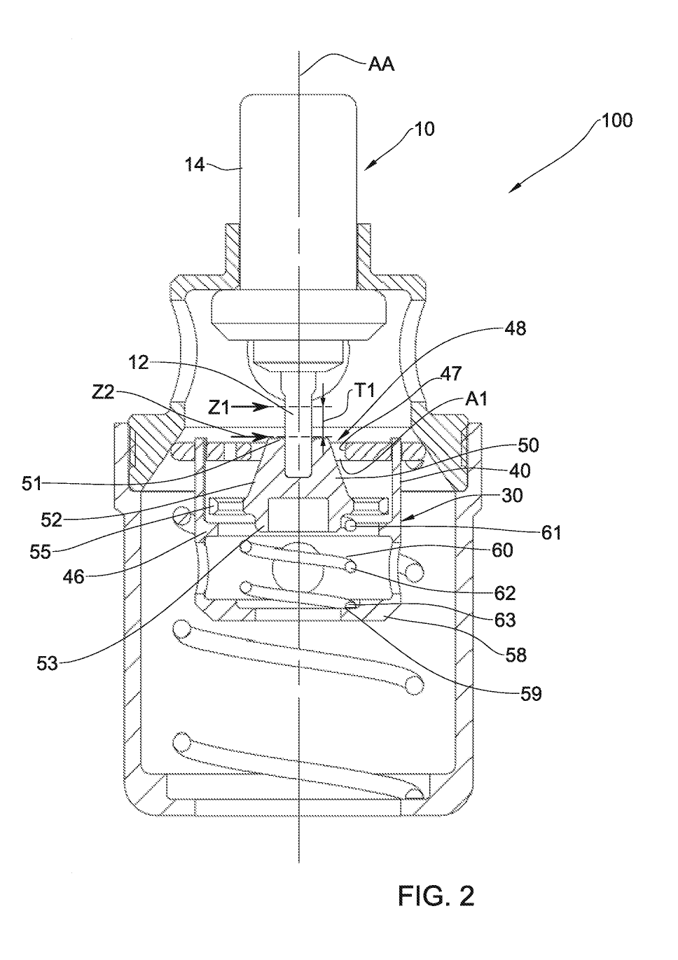

Referring in particular to FIG. 2, the first valve unit 30, and in particular the first valve housing 40, defines a first valve seat 47 in fixed spatial relationship thereto. The first valve seat 47 in this example is defined by a peripheral edge of the third port 48, and cooperates with a first valve element 50 to selectively sealingly close or open the third port 48. The first valve element 50 is reciprocally movable axially with respect to the first valve seat 47 between a first closed position (see FIG. 1) and a first open position (see FIG. 2). In the first closed position the first valve element 50 is in sealing contact with the first valve seat 47, with the first valve element 50 at position Z1, this being the top dead center position, i.e., the uppermost position as viewed in FIG. 1, of the first valve element 50.

In the first open position (see FIG. 2) the first valve element 50 is axially displaced away from the first ports 78 in a forward first stroke T1 to a maximum displacement at position Z2, and is concurrently spaced from the first valve seat 47 defining a variable first flow area A1 therethrough during this displacement, to thereby open the first fluid path P1.

The first valve element 50 in this example is generally frusto-conical, having a cross-sectional area increasing from its narrow end 51 to its wider end 53, and a frusto-conical contact surface 52 facing generally away from longitudinal axis AA. The frusto-conical contact surface 52 provides sealing contact with first valve seat 47 in the first closed position. Thus, as the first valve element 50 is displaced along the forward first stroke T1 from position Z1 to position Z2, the flow area A1 increases from zero (corresponding to the first closed position) to a maximum flow area A1ₘₐₓ (corresponding to the first open position). Conversely in the reverse first stroke T1, as the first valve element 50 is displaced from position Z2 to position Z1, the first flow area A1 decreases from the maximum flow area A1ₘₐₓ to zero, and the variation of first flow area A1 with first stroke T1 is referred to herein as the first variation S1.

The wider end 53 of the first valve element 50 includes a lateral projection 55 in the form of an annular disk that abuts shoulder 46, provided in the first valve housing 40 when the first valve element 50 is at the end of the first forward stroke T1 to fully open the third port 48. The lateral projection 55 and shoulder 46 operate as mechanical stops.

The first valve unit 30 further comprises a first mechanical biasing element 60 for biasing the first valve element 50 to the closed position. In this example, the biasing element is in the form of a pre-stressed coiled spring 62, having a first axial spring end 61 of the spring in abutting contact with the first valve element 50, and having a second axial spring end 63 in contact with the first valve housing 40. In particular, the first axial spring end 61 is abutting an inner-facing side of the first valve element 50, while the second axial spring end 63 is seated on a recess or shoulder 59 formed at the bottom end 58 of the first valve housing 40.

In alternative variations of this example, the first mechanical biasing element 60 can take a different form.

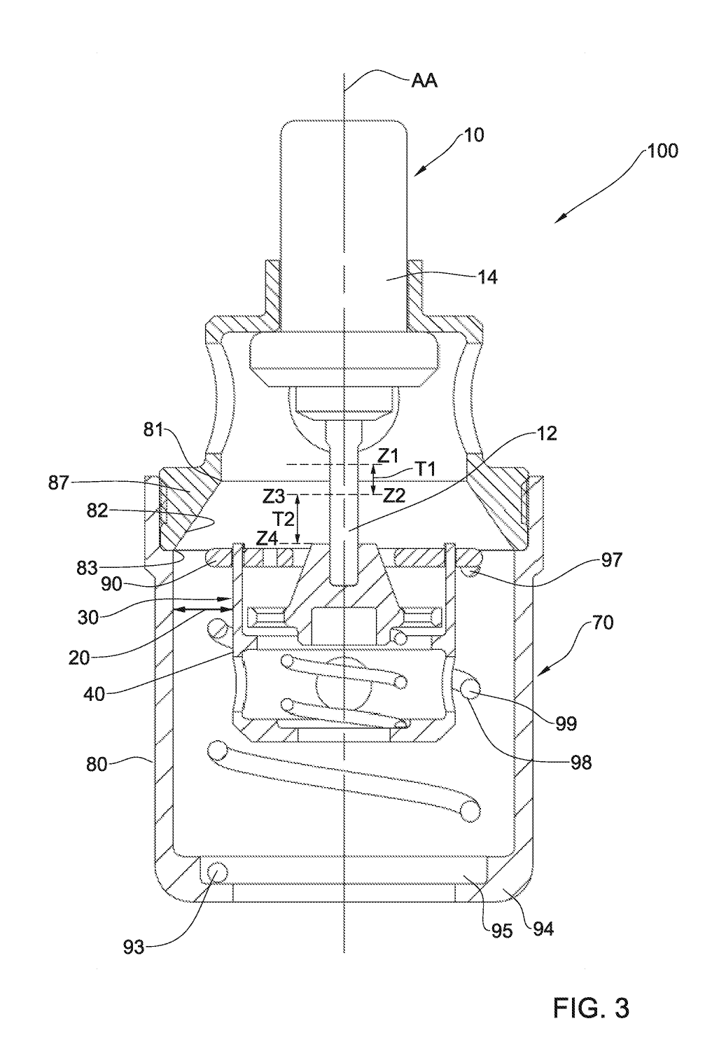

Referring in particular to FIG. 3, the first valve unit 30 is movably mounted within the second valve housing 80 in an axial direction parallel to longitudinal axis AA, such as to provide an annular gap 20 between the inside of the second valve housing 80 and the outside of the first valve housing 40.

The second valve unit 70, and in particular the second valve housing 80, defines a second valve seat 87 in fixed spatial relationship thereto. The second valve seat 87 in this example is defined by an annular frusto-conical contact surface 82 facing generally towards the longitudinal axis AA, and having a cross-sectional area increasing from its narrow end 81 to its wider end 83.

The second valve seat 87 cooperates with a second valve element to selectively sealingly close or open fluid flow through the annular gap 20, i.e., to selectively sealingly close or open the second fluid path P2.

The second valve element 90 is spatially fixed with respect to the first valve unit 30, and thus moves reciprocally within the second valve housing 80 together with the first valve unit 30. In this example, the second valve element 90 is affixed, in particular mechanically fixed, to the first valve unit 30.

In particular, second valve element 90 is movable axially with respect to the second valve seat 87 between a second closed position (see FIGS. 1 and 2) and a second open position (see FIG. 3). In the second closed position the second valve element 90 is sealing contact with the second valve seat 87, with the second valve element 90, and thus the first valve unit 30 at position Z3, this being the top dead center position, i.e., the uppermost position as viewed in FIGS. 1 and 2, of the second valve element 90, and thus of the first valve unit 30.

In the second open position (see FIG. 3) the second valve element 90 is axially displaced away from first ports 78 in a forward second stroke T2 to a maximum displacement at position Z4, and is concurrently spaced from the second valve seat 87 defining a variable second flow area A2 there through during this displacement, to thereby open the second fluid path P2.

The second valve element 90 in this example is generally annular, having an edge a 92 that provides sealing contact with second valve seat 87 in the second closed position. Thus, as the second valve element 90 is displaced along the forward second stroke T2 from position Z3 to position Z4, the second flow area A2 increases from zero (corresponding to the second closed position) to a maximum second flow area A2ₘₐₓ (corresponding to the second open position). Conversely, in the reverse second stroke T2, as the second flow element 90 is displaced form position Z4 to position Z3, the second flow area A2 decreases from the maximum second flow area A2ₘₐₓ to zero, and the variation of second flow area A2 with second stroke T2 is referred to herein as the second variation S2.

The second valve unit 70 further comprises a second mechanical biasing element 99 for biasing the second valve element 90 in the closed position. The second biasing element 99 is different and separate from the first biasing element. In this example, the second biasing element is in the form of a pre-stressed coiled spring 98, having a first axial spring end 97 of the spring in abutting contact with the second valve element 90, and having a second axial spring end 93 in contact with the second valve housing 80. In particular, the first axial spring end 97 is abutting an inner-facing side of the second valve element 90, while the second axial spring end 93 is seated on a recess or shoulder 95 formed at the bottom end 94 of the second valve housing 80.

In alternative variations of this example, the second mechanical biasing element can take a different form.

Referring again to FIGS. 1 to 3, the valve assembly 100 further comprises a reciprocal actuator element 10 configured for reciprocally displacing the first valve unit 30. In this example, the reciprocal actuator element 10 is configured for reciprocably displacing the first valve unit 30 responsive to actuator element 10 being exposed to a predetermined temperature range TR, and thus enables the valve assembly 100 to operate as a thermostat.

In this example, the actuator element 10 comprises a pin or piston element 12 reciprocably movable with respect to piston housing 14. The piston housing 14 is fixed to the second valve housing 80, while the piston element 12 is fixed to the narrow end 51 of the first valve element 50. The piston housing 14 is filled with a thermally expansive material, for example wax. Thus, as the actuator element 10 is heated through a predetermined temperature range TR beyond a threshold temperature T₀, the thermally expansive material expands, and in response thereto the piston element 12 is corresponding displaced out of the piston housing 14. Conversely, as the actuator element 10 is cooled through the predetermined temperature range TR, the thermally expansive material contracts, and in response thereto Furthermore, at temperatures below the threshold temperature T₀, the piston element 12 remains in the fully retracted position in the piston housing 14, and the first mechanical biasing element 60 and/or the second mechanical biasing element 99 urge the piston element 12 to the retracted position.

In this example, the first mechanical biasing element 60 is less stiff than the second mechanical biasing element 99, and thus the force required to compress the first mechanical biasing element 60 is less than that required to compress the second mechanical biasing element 99.

The valve assembly 100 can operate in a number of different ways. For example, the valve assembly 100 is located in a cooling circuit, and is configured to open to allow cooling fluid to flow through the valve assembly 100 to provide cooling to a heat source, for example electronic components via a heat exchanger, when the temperature sensed by the actuator element 10 exceeds the threshold temperature T₀.

At temperatures at or below the threshold temperature T₀, the piston element 12 remains fully retracted in the piston housing 14, and correspondingly, the first valve unit 30 and the second valve unit 70 are both in the respective first and second closed positions, shown in FIG. 1. In other words, the first valve element 50 is in the first closed position and the second valve element 90 is in the second closed position.

Referring also to FIG. 4(a), when the actuator element 10 is heated beyond the threshold temperature T₀, for example by being exposed directly or indirectly to the heat source, the piston element 12 begins to be displaced out of the piston housing 14 responsive to the thermal expansion of the thermally expansive material. The piston element 12 correspondingly displaces the first valve element 50 against the biasing force provided by the first mechanical biasing element 60, since in this example the compressive force (provided by the piston element 12) required to compress the first mechanical biasing element 60 is significantly less than that required to compress the second mechanical biasing element 99. Concurrently, the second valve unit 70 remains in the closed position. As such, as the piston element 12 is displaced through (part or all of) the first stroke T1, corresponding to (part or all of) a first temperature range TR1, the first flow area A1 available for cooling fluid to flow along the first fluid path P1 progressively and correspondingly increases from zero up to A1ₘₐₓ, at which time the lateral projection 55 abuts the shoulder 46 and further displacement of the first valve element 50 with respect to the first valve casing 40 is prevented.

Referring also to FIG. 4(b), additional displacement of the piston element 12, as the temperature felt by the actuator element 10 is further increased beyond the first temperature range TR1, is initially resisted by the second mechanical biasing element 99 until the temperature reaches a second threshold temperature Tₙ. Thereafter, the compressive force provided by the piston element 12 is now sufficient to begin to compress the second mechanical biasing element 99. At this point, the as the piston element 12 is displaced through (part or all of) the second stroke T2, corresponding to (part or all of) a second temperature range TR2, the second flow area A2 available for cooling fluid to flow along the second fluid path P2 now progressively and correspondingly increases from zero up to A2ₘₐₓ, while concurrently the first valve element 50 remains in the fully open position and the first flow area is maintained at A1ₘₐₓ.

As the temperature felt by the actuator element begins to reduce through the second temperature range TR2, second threshold temperature Tₙ, first temperature range TR1, and first threshold temperature T₀, the piston element 12 follows a reverse stroke, first closing the second fluid flow path P2 and then the first fluid flow path P1, in a reverse manner to that disclosed above, mutatis mutandis.

In this example, the first threshold temperature T₀ is about 83° C., the first temperature range TR1 is 83° C. to 90° C., the second threshold temperature Tₙ is about 90°, and the second temperature range TR2 is 90° C. to 98° C. However, in alternative variations of this example, different values may be provided for one or more of: first threshold temperature T₀, the first temperature range TR1, the second threshold temperature Tₙ, and the second temperature range TR2.

It is evident that the second stroke T2 is contiguous with the first stroke T1, and that position Z2 corresponds to position Z3.

Thus, the valve assembly 100 operates as a two stage, two port valve, wherein a first valve stage and a second valve stage open consecutively between the same two sets of ports. The first valve stage, corresponding to the first valve unit 30, operates to open at a particular temperature range TR1 to allow a particular cooling flow rate therethrough (via the first flow path P1). The second valve stage, corresponding to the second valve unit 70, operates to subsequently open at a higher temperature range TR2, allowing then additional fluid to flow along the second fluid flow path P2, and thereby further opening the aggregate flow area through the valve assembly 100 to further increase the total flow rate through the valve.

For the purpose of non-limiting example, Table I below provides a variation of a number of geometrical parameters and mechanical parameters as a function of stroke of the piston element 12, for one particular application of the example of the valve assembly 100 having the geometry illustrated in FIGS. 1 to 3.

TABLE I
Variations of Selected Parameters of an Example of the
Valve Assembly as a Function of Stroke

| | | | load in | load in | spring |
|---|---|---|---|---|---|
| | | | first | second | load |
| | | equivalent | biasing | biasing | applied by |
| Stroke | Area | diameter | element | element | piston |
| (mm) | (mm²) | (mm) | (N)* | (N)** | element |
| 0 | 1.77 | 1.50 | 50.35 | 80 | 50.35 |
| 0.5 | 7.95 | 3.18 | 52.85 | 80 | 52.85 |
| 1 | 13.93 | 4.21 | 55.35 | 80 | 55.35 |
| 1.5 | 19.70 | 5.01 | 57.85 | 80 | 57.85 |
| 2 | 25.26 | 5.67 | 60.35 | 80 | 60.35 |
| 2.5 | 30.61 | 6.24 | 62.85 | 80 | 62.85 |
| 3 | 35.76 | 6.75 | 65.35 | 80 | 65.35 |
| 3.5 | 40.69 | 7.20 | 67.85 | 80 | 67.85 |
| 4 | 45.42 | 7.60 | 70.35 | 80 | 70.35 |
| 4.5 | 49.94 | 7.97 | 72.85 | 80 | 72.85 |
| 5 | 54.26 | 8.31 | 75.35 | 83.85 | 159.2 |
| 5.5 | 372.40 | 21.78 | 75.35 | 87.7 | 163.05 |
| 6 | 396.54 | 22.47 | 75.35 | 91.55 | 166.9 |
| 6.5 | 419.91 | 23.12 | 75.35 | 95.4 | 170.75 |
| 7 | 442.51 | 23.74 | 75.35 | 99.25 | 174.6 |
| 7.5 | 464.34 | 24.31 | 75.35 | 103.1 | 178.45 |
| 8 | 485.40 | 24.86 | 75.35 | 106.95 | 182.3 |
| 8.5 | 505.68 | 25.37 | 75.35 | 110.8 | 186.15 |
| 9 | 525.20 | 25.86 | 75.35 | 114.65 | 190 |
| 9.5 | 543.95 | 26.32 | 75.35 | 118.5 | 193.85 |
| 10 | 561.93 | 26.75 | 75.35 | 122.35 | 197.7 |
| 10.5 | 579.14 | 27.15 | 75.35 | 126.2 | 201.55 |
| 11 | 595.58 | 27.54 | 75.35 | 130.05 | 205.4 |
| 11.5 | 651.61 | 28.80 | 75.35 | 133.9 | 209.25 |
| 12 | 651.61 | 28.80 | 75.35 | 137.75 | 213.1 |
| 12.5 | 651.61 | 28.80 | 75.35 | 141.6 | 216.95 |
| 13 | 651.61 | 28.80 | 75.35 | 145.45 | 220.8 |

*in this example the length of the small spring is 24 mm, and the spring has a spring constant of 5.3
**in this example the length of the large spring is 65 mm, and the spring has a spring constant of 3.2

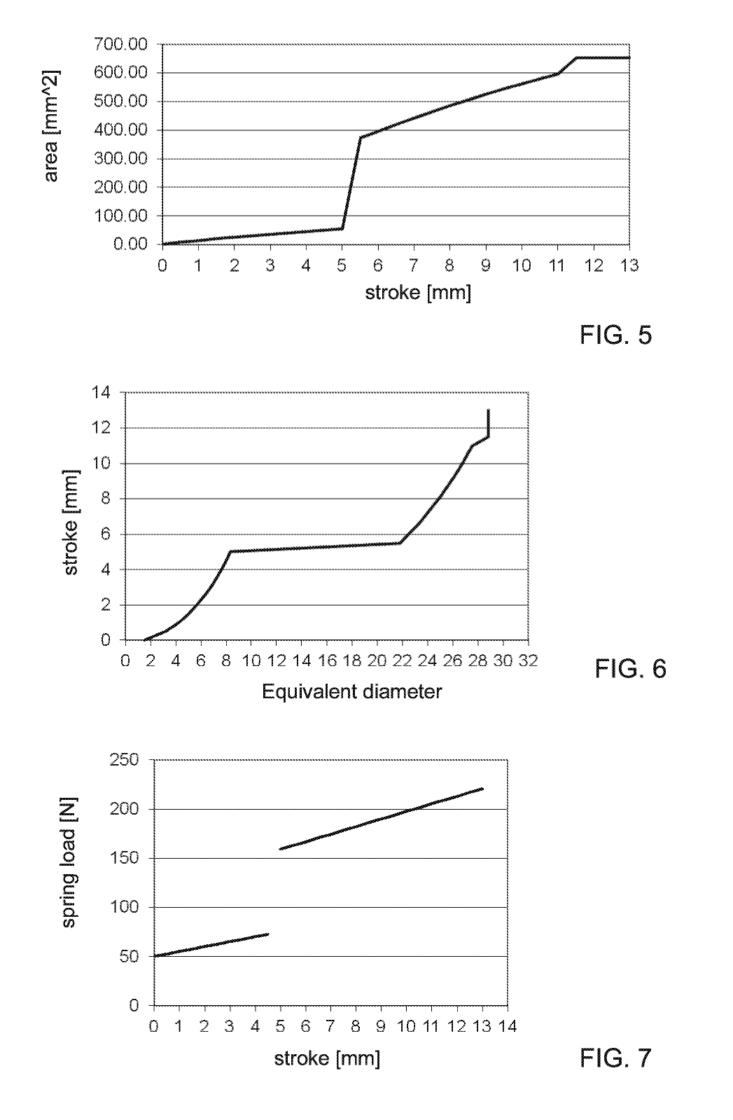

FIG. 5, based on Table I, graphically illustrates the variation of aggregate flow (i.e., area A₁ plus area A₂) as a function of stroke. As the piston element 12 is displaced through the first stroke T1 (in the illustrated example, 0 to 5 mm), the first flow area A₁ opens at a relatively slow rate from zero to 54.26 mm² (i.e., flow area Aₘₐₓ is less than 10% of the combined maximum area (A_{1 max}+A_{2 max})), and the second flow area A₂ remains at zero. As the piston element 12 continues through the second stroke T2 (in this example from 5 mm to 13 mm, i.e., 8 mm total), there is an enormous increase in flow area as the second valve unit 70 begins to open, increasing the aggregate flow area almost immediately to 372.40 mm² only 0.5 mm into the second stroke T2. Thereafter, the aggregate flow area increases more slowly to about 651.61 mm² at the end of the second stroke T2. In this specific example, the aggregate flow area tops at this value before the end of the second stroke T2. This effect is also illustrated in FIG. 6, which shows the variation of equivalent diameter (i.e., the diameter of a fictitious circle having the corresponding aggregate flow area) with stroke.

FIG. 7 graphically illustrates the aggregate spring loads (i.e., the summation of the loads) applied to the first biasing element 60 and the second biasing element 99. The first biasing element 60 is initially prestressed to 50.35 N, and the second biasing element 99 is initially prestressed to 80 N at the respective first and second closed positions. As the piston element 12 is displaced through the first stroke T1 (in the illustrated example, 0 to 5 mm), the first biasing element 60 is loaded at a relatively slow rate from 50.35 N to 72.85 N, while the second biasing element 99 remains in the prestressed condition at 80 N, and thus the loading provided by the piston element 12 increases from 50.35 N to 72.85 N. As the piston element 12 continues through the second stroke T2 (in this example from 5 mm to 13 mm, i.e., 8 mm total), there is concurrently required a relatively large increase in the loading provided by the piston element 12 in order to open the second valve unit 70. Thus at the beginning of the second stroke T2, the total loading provided by the piston element 12 jumps to 159.20 N, and thereafter the loading on the first biasing element 60 tops and remains at 75.35 N, while the loading on the second biasing element 99 increases with the stroke to a maximum of 145.45 N, bring the total loading to 220.80 N at the end of the second stroke T2.

In the example illustrated in FIGS. 4(a) and 4(b), the valve assembly 100 comprises at least one bleed orifice 69, in the first valve unit. In the illustrated example, the at least one bleed orifice 69 is in the form of one or more through-holes provided in the annular end wall 41. The bleed orifice 69 is always open, and allows a limited fluid flow to be present through the valve assembly 100 whenever there is a pressure difference across the valve assembly, for example where a pump is operating for the fluid flow. The constant fluid flow avoids stagnation of the fluid at either side of the valve assembly 100, and can avoid overheating of such a pump. In alternative variations of this example, the at least one bleed orifice 69 is provided in the second valve unit, for example in second valve element 90, in addition to or instead of the at least one bleed orifice 69 in the first valve unit. In yet other alternative variations of this example, the bleed orifice 69 is omitted from the valve assembly 100. In the example illustrated in FIGS. 4(a) and 4(b), the valve assembly 100 is illustrated as operating to provide the first fluid path P1 and the second fluid path P2 to allow fluid to flow from the first ports 78 to the second port 79. In such a case, the prestress loads in the first biasing element 60 and in the second biasing element 99 must be sufficient to retain the respective first valve unit 30 and the second valve unit 70 closed (at the minimum threshold temperature), against the pressure difference across each valve unit generated by the flow circuit in which the valve assembly is comprised.

However, it is also possible to operate the valve assembly 100 in an inverted manner, in which the first fluid path P1 and the second fluid path P2 to allow fluid to flow from the second port 79 to the first ports 78. In such a case, the prestress loads in the first biasing element 60 and in the second biasing element 99 can be less than in the example illustrated in FIGS. 4(a) and 4(b), since the pressure difference across each valve unit (generated by the flow circuit in which the valve assembly is comprised) now assists in biasing the respective first valve unit 30 and the second valve unit 70 towards the respective first and second closed positions. In at least some such cases the actuator element remains in a position such as to be exposed to the heat generated by the heat source.

In alternative variations of this example, the first mechanical biasing element 60 is stiffer than the second mechanical biasing element 99, and thus the force required to compress the first mechanical biasing element 60 is more than that required to compress the second mechanical biasing element 99. In such a case, as the valve assembly 100 operates responsive to an increase in temperature to displace the piston element 12, first the second valve unit 70 opens the second flow path P2 to provide a flow area from zero to A_{2 max}, along a primary stroke (corresponding in length to the second stroke T2) and thereafter as the stroke continues via a secondary stroke contiguous with the primary stroke, the first valve unit 30 opens the first flow path P1, addling the first flow area A1 to the aggregate flow area through the valve assembly, the first flow area increasing from zero to A_{1 max} at the end of the secondary stroke (corresponding in length to the first stroke T1). In such an example, a mechanical stop arrangement can be provided to mechanically abut the first valve housing 40 with respect to the second valve housing 80 at the end of the primary stroke and when the maximum second flow area has been reached. In such an example, the lateral projection 55 and the shoulder 46 can optionally be omitted.

In yet another alternative variation of this example, the first mechanical biasing element 60 is as stiff as the second mechanical biasing element 99, and thus the force required to compress the first mechanical biasing element 60 is the same as that required to compress the second mechanical biasing element 99. In such a case, as the valve assembly 100 does not operate as a two stage valve, but rather the first valve unit 30 and the second valve unit 70 can concurrently open the respective first flow path P1 and the respective second flow path P2.

In alternative variations of the above examples, the actuator element 10 is controllably actuable to displace the first valve unit 30 in a controlled manner to operate the valve assembly in any one of many different ways, optionally independent of the temperature applied to the actuator element. For example, the actuator element 10 comprises a solenoid or linear motor or a similar arrangement that displaces the first valve unit 30 responsive to receiving electrical signals or electronic signals or digital commands for a controllable displacement.

In alternative variations of the above examples, the valve assembly can include more than two stages, i.e., can include more than two valve units in nested configuration, in which each an inner valve unit (corresponding to the first valve unit) is movably mounted in another valve unit, which is itself movably mounted in another valve unit, and so on up to an outermost valve unit (corresponding to the second valve unit), so that each valve unit selectively opens (or closes) in a sequential manner to thereby open (or close) a different fluid flow path between the first port set and the second port set, responsive to a corresponding forward stroke (or rearward stroke).

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the spirit of the presently disclosed subject matter.

1. A valve assembly comprising at least a first valve unit and a second valve unit:
the first valve unit movably mounted within the second valve unit, the first valve unit comprising a first valve housing defining a first valve volume, and the second valve unit comprising a second valve housing defining a second valve volume different from said first valve volume, the second valve housing further comprising a first port set comprising at least one first port and a second port set comprising at least one second port;
the first valve unit further comprising:
a first valve seat defined in the first valve housing,
a first valve element reciprocably movable with respect to the first valve seat between a first open position and a first closed position to respectively selectively open and close a first fluid path defined between said first port set and said second port set through the first valve volume,
a first mechanical biasing element cooperating with the first valve element for biasing the first valve element in the first closed position;
the second valve unit further comprising:
a second valve seat defined in the second valve housing,
a second valve element reciprocably movable with respect to the second valve seat between a second open position and a second closed position to respectively selectively open and close a second fluid path defined between said first port set and said second port set through the second valve chamber, said second valve element being affixed to first valve housing for reciprocal movement therewith,
a second mechanical biasing element different from said first biasing element and cooperating with the second valve element for biasing the second valve element in the second closed position;
wherein the first valve unit is connectable to a reciprocable actuator element, the first valve element and the second valve elements being reciprocally movable responsive to reciprocal movement of the reciprocable actuator element to selectively open the first flow path and the second flow path, respectively.

2. The valve assembly according to claim 1, wherein the first valve element and the second valve elements are reciprocally movable sequentially responsive to reciprocal movement of said reciprocable actuator element.

3. The valve assembly according to claim 2, wherein said first biasing element and the second biasing element are configured for allowing said first valve element to open to said first open position at a first displacement of the first valve element and for the second valve element to open to said second open position at a second displacement of the first valve element, the second valve displacement being subsequent to said first displacement.

4. The valve assembly according to claim 3, wherein said first biasing element is less stiff than said first biasing element.

5. The valve assembly according to claim 2, wherein said first biasing element and the second biasing element are configured for allowing said second valve element to open to said second open position at a first displacement of the first valve element and for the first valve element to open to said first open position at a second displacement of the first valve element, the second valve displacement being subsequent to said first displacement.

6. The valve assembly according to claim 5, wherein said first biasing element is stiffer than said first biasing element.

7. The valve assembly according to claim 1, wherein the first valve element and the second valve elements are concurrently movable sequentially responsive to reciprocal movement of said reciprocable actuator element.

8. The valve assembly according to any one of claims 1 to 7, wherein said first biasing element comprises a prestressed first spring element having one axial end thereof fixed to the first valve element, and a second axial end thereof fixed to a spring seat provided in said first valve housing.

9. The valve assembly according to claim 8, wherein said first spring element is a first helical spring.

10. The valve assembly according to any one of claims 1 to 9, wherein said second biasing element comprises a prestressed second spring element having one axial end thereof fixed to the second valve element, and a second axial end thereof fixed to a spring seat provided in said second valve housing.

11. The valve assembly according to claim 10, wherein said second spring element is a second helical spring.

12. The valve assembly according to any one of claims 1 to 11, further comprising the reciprocable actuator element.

13. The valve assembly according to claim 12, wherein the reciprocable actuator element comprises a piston element reciprocably movable with respect to a piston housing, the piston housing being fixed to the second valve housing, and the piston element being fixed to the first valve element.

14. The valve assembly according to claims 12 to 13, wherein the reciprocable actuator element is movable responsive to being exposed to a temperature above a threshold temperature.

15. The valve assembly according to claims 12 to 14, wherein the reciprocable actuator element comprises a thermally expansive material.

16. The valve assembly according to any one of claims 1 to 15, further comprising at least one bleeding orifice for allowing a limited fluid flow to be present through the valve assembly whenever there is a pressure difference across the valve assembly.

17. The valve assembly according to claim 16, wherein the at least one bleeding orifice is provided in the first valve unit.

18. The valve assembly according to claim 16, wherein the at least one bleeding orifice is provided in the second valve unit.

19. A cooling circuit comprising a valve assembly as defined in any one of claims 1 to 18.

20. Method for operating a valve assembly, comprising:
(a) providing in a cooling circuit a valve assembly as defined in any one of claims 1 to 18;
(b) exposing the valve assembly of a first temperature range above the threshold temperature to thereby open the first low path; and
(c) exposing the valve assembly of a second temperature range above the threshold temperature to thereby open the second low path.
